(19) United States
(12) Patent Application Publication
(10) Pub. No.: US 2026/0296333 A1
(43) Pub. Date: Oct. 1, 2026

(54) Structure for Mounting Ornamental Panel on Vehicle Interior Material

(71) Applicants: SHIGERU CO., LTD., Ota-shi (JP); SUBARU CORPORATION, Tokyo (JP)

(72) Inventors: Takahiro Shimizu, Ota-shi (JP); Koichi Inaba, Tokyo (JP)

(21) Appl. No.: 19/096,940

(22) Filed: Apr. 1, 2025

(51) Int. Cl. B60R 13/02; F16B 5/02

(52) U.S. Cl. CPC B60R 13/0206; F16B 5/02

(57) ABSTRACT

In a structure for mounting a second ornamental panel on a first ornamental panel having an airbag device disposed in a reverse face side of the first ornamental panel, the first and second ornamental panels are made of an injection molded resin. The second ornamental panel is fixed to the first ornamental panel by a first fixer. The second ornamental panel can be further fixed to the first ornamental panel by a second fixer. The second fixer includes a boss portion and a receiving recess. The boss portion having a tapping hole is protrudedly disposed on a reverse side of the second ornamental panel. The receiving recess recessed in a protrusion direction of the boss portion is formed in the first ornamental panel. The receiving recess receives the boss portion. The receiving recess includes a bottom wall portion opposed to a distal end of the boss portion. A protrusion length of the boss portion is determined such that a clearance is formed between the bottom wall portion and the distal end of the boss portion.

### BACKGROUND

The present disclosure relates to a structure for mounting an ornamental panel on a vehicle interior material.

A vehicle interior material may have an ornamental panel mounted thereon to improve ornamental property. An instrument panel as a vehicle interior material generally has an airbag device for a front passenger seat disposed therein. When the airbag device for the front passenger seat is deployed, an impact thereof may affect the instrument panel, and the ornamental panel may come off the instrument panel and fly in to an interior of the vehicle. It is required to secure the ornamental panel with sufficient fixation strength for preventing the ornamental panel from coming off for safety of occupants.

Unexamined Japanese Patent Application Publication No. H07-40765 discloses a mounting structure for mounting a finisher (ornamental panel) on an instrument panel (vehicle interior material). In the mounting structure, a fitting plate in a reverse side of the finisher and a fitting hole of the instrument panel, as fixing means, are engaged with each other. Thereby, the finisher is fixed to the instrument panel.

### SUMMARY

One embodiment of the present disclosure provides a structure for mounting an ornamental panel on a vehicle interior material. The structure for mounting the ornamental panel has an airbag device disposed in a reverse face side of the vehicle interior material. The interior material and the ornamental panel are made of an injection molded resin. The ornamental panel is fixed to the interior material by a first fixer. The ornamental panel can be fixed to the interior material by a second fixer.

The second fixer includes a boss portion and a receiving recess. The boss portion having a tapping hole is protrudedly disposed on a reverse side of the ornamental panel. The receiving recess recessed in a protrusion direction of the boss portion is formed in the interior material. The receiving recess receives the boss portion. The receiving recess includes a bottom wall portion opposed to a distal end of the boss portion.

A protrusion length of the boss portion is determined such that a clearance is formed between the bottom wall portion and the distal end of the boss portion.

A structure for mounting an ornamental panel on a vehicle interior material according to another embodiment of the present disclosure has an airbag device disposed in a reverse face side of the vehicle interior material. The interior material and the ornamental panel are made of an injection molded resin. The ornamental panel is fixed to the interior material by a first fixer. The ornamental panel is further fixed to the interior material by a second fixer that adds to a fixation strength by the first fixer.

The second fixer comprises a tapping screw, a boss portion and a receiving recess. The boss portion having a tapping hole is protrudedly disposed on a reverse side of the ornamental panel. The receiving recess recessed in a protrusion direction of the boss portion is formed in the interior material. The receiving recess receives the boss portion. The receiving recess includes a bottom wall portion opposed to a distal end of the boss portion.

An under hole opposed to the tapping hole of the boss portion is formed in the bottom wall portion. A height of the boss portion is determined such that the bottom portion and the distal end of the boss portion are abutted against each other. The tapping screw is screwed into the tapping hole of the boss portion from a reverse side of the bottom wall portion through the under hole.

### BRIEF DESCRIPTION OF THE DRAWINGS

The accompanying drawings are included to provide a further understanding of the disclosure and are incorporated in and constitute a part of this specification. The drawings illustrate example embodiments and, together with the specification, serve to explain the principles of the disclosure.

FIG. 1 is a perspective view of a passenger seat side of an instrument panel of a vehicle, showing an ornamental panel mounted on a vehicle interior material with a mounting structure according to one embodiment of the present invention.

FIG. 2 is a cross-sectional view taken along line II-II of FIG. 1, showing the ornamental panel that is not secured with a second fixer.

FIG. 3 is a perspective view of the ornamental panel.

FIG. 4 is an enlarged view of a circled portion IV of FIG. 2.

FIG. 5 is an enlarged view corresponding to the circled portion IV of FIG. 2, showing the ornamental panel that is secured with the second fixer.

FIG. 6 is an enlarged view corresponding to the circled portion IV of FIG. 2, showing a receiving recess having an under hole formed in a bottom wall portion thereof, with a boss portion abutted against the bottom wall portion.

FIG. 7 is a view corresponding to FIG. 6, with the ornamental panel secured with the second fixer.

FIG. 8A is an enlarged cross-sectional view of a mold for forming the vehicle interior material, showing a vicinity of the receiving recess in a case where the under hole is not formed in the bottom wall portion.

FIG. 8B is an enlarged cross-sectional view of the mold for forming the vehicle interior material, showing a vicinity of the receiving recess in a case where the under hole is formed in the bottom wall portion.

FIG. 9A is an enlarged cross-sectional view of a mold for forming the ornamental panel, showing a vicinity of the boss portion in a case where a protrusion length of the boss portion is short.

FIG. 9B is an enlarged cross-sectional view of the mold for forming the ornamental panel, showing a vicinity of the boss portion in a case where the protrusion length of the boss portion is long.

### DETAILED DESCRIPTION

An ornamental panel to be mounted on a vehicle interior material is tested in a prototype stage to determine whether the ornamental panel is fixed with a sufficient fixation strength to the vehicle interior material. If the ornamental panel is fixed with a sufficient fixation strength, it may be put into production. The mounting structure disclosed in Unexamined Japanese Patent Application Publication No. H07-40765, although not possessing a sufficient fixation strength, is not provided with other fixing means for enhancing fixation strength. Therefore, it is desired to provide a structure for mounting an ornamental panel on a vehicle interior material that solves the problems mentioned above.

In the following, an embodiment of the disclosure is described in detail with reference to the accompanying drawings. Note that the following description is directed to an illustrative example of the disclosure and not to be construed as limiting to the disclosure. Factors including, without limitation, numerical values, shapes, materials, components, positions of the components, and how the components are coupled to each other are illustrative only and not to be construed as limiting to the disclosure. Further, elements in the following example embodiment which are not recited in a most-generic independent claim of the disclosure are optional and may be provided on an as-needed basis. The drawings are schematic and are not intended to be drawn to scale. Throughout the present specification and the drawings, elements having substantially the same function and configuration are denoted with the same numerals to avoid any redundant description.

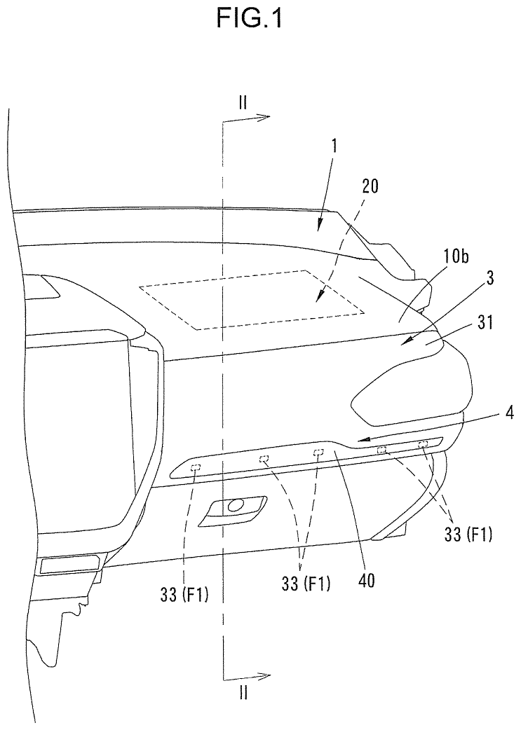

A structure for mounting an ornamental panel on a vehicle interior material according to one embodiment of the present disclosure is described hereinafter with reference to FIG. 1 to FIG. 9B. In this embodiment, the present disclosure is applied to a mounting structure between an ornamental panel (interior material) mounted on an instrument panel of a vehicle and another ornamental panel.

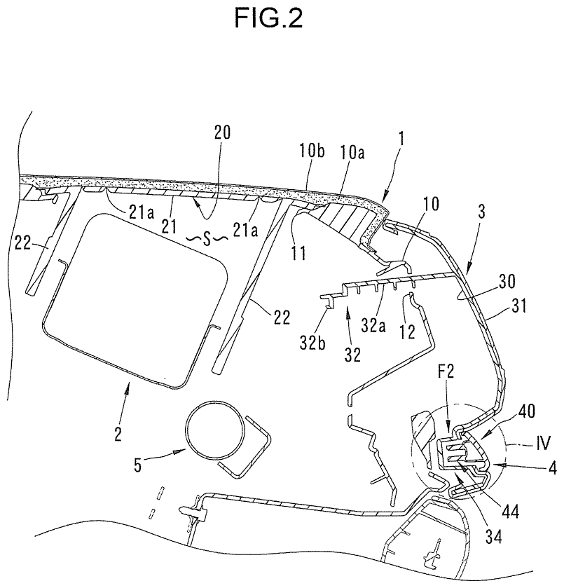

As shown in FIGS. 1 and 2, a vehicle such as an automobile is provided with an instrument panel 1 as an interior material in a front portion in an interior of the vehicle. The instrument panel 1 has an airbag device 2 disposed in a receiving space S on a reverse side on a passenger seat side thereof. The instrument panel 1 also has an ornamental panel 3 as an interior material for enhancing ornamental property mounted thereon from a surface side (vehicle interior side) thereof. In this embodiment, an ornamental panel 4 as an interior material for enhancing ornamental property is further mounted on the ornamental panel 3 from the vehicle interior side. The ornamental panel 4 is fixed to the ornamental panel 3 with a first fixer F1, and is designed to be able to be further fixed with a second fixer F2.

### Instrument Panel 1

The instrument panel 1 has a configuration that is long in a vehicle width direction. As shown in FIG. 2, the instrument panel 1 includes a core material 10 formed by injection molding a relatively hard synthetic resin. A portion of a surface of the core material 10 is covered with a cushion material 10a and a surface skin 10b laminated to each other. The cushion material 10a is made of a foamed resin and is disposed between the core material 10 and the surface skin 10b. The surface skin 10b is made of a synthetic resin and has a design surface.

A mounting hole 11 passing through the core material 10 is formed in a top surface of the core material 10 of the instrument panel 1 on the passenger seat side. An airbag lid 20 is mounted in the mounting hole 11. The airbag lid 20 may be formed by injection molding a synthetic resin similar to the one used for the core material 10. The airbag lid 20 integrally has a lid portion 21 and a frame portion 22. A surface of the lid portion 21 is covered with the cushion material 10a and the surface skin 10b that cover the surface of the core material 10 of the instrument panel 1.

A weak potion 21a having a groove configuration is formed in a reverse face of the lid portion 21. The weak portion 21a is broken when the airbag device 2 is deployed. The frame portion 22 is protruded from the reverse face of the lid portion 21. A space surrounded by the lid portion 21 and the frame portion 22 serves as the receiving space S mentioned above that receives the airbag device 2. The airbag device 2 is caught by the frame portion 22 and is fixed to a steering support member 5 via a bracket that is not shown.

### Ornamental Panel 3

In this embodiment, the ornamental panel 3 is mounted on the instrument panel 1 at a location opposed to a passenger seat as shown in FIGS. 1 and 2. The ornamental panel 3 includes a body portion 30 formed by injection molding a relatively hard synthetic resin. The body portion 30 has an elongated configuration elongated in the vehicle width direction. A surface of the body portion 30 is covered with a soft surface skin 31.

The ornamental panel 3 includes a plurality of catch claws that are not shown on a reverse side of the body portion 30. A plurality of catch holes that are not shown are formed in the core material 10 of the instrument panel 1 at locations corresponding to the catch claws. The catch claws are respectively caught in the catch holes, thereby the ornamental panel 3 is securely mounted on the core material 10 of the instrument panel 1.

As shown in FIG. 2, the ornamental panel 3 includes an anchor 32 protruded from a reverse face of the body portion 30. The anchor 32 is provided for preventing the ornamental panel 3 from dropping off the instrument panel 1. The anchor 32 includes an insertion portion 32a and a hook portion 32b. The insertion portion 32a is integrally formed with the body portion 30 and extends toward the instrument panel 1. The hook portion 32b is disposed in a distal end portion of the insertion portion 32a.

The insertion portion 32a and the hook portion 32b are inserted in an insertion hole 12 formed in the instrument panel 1 when the ornamental panel 3 is mounted on the instrument panel 1. When the ornamental panel 3 is detached from the instrument panel 1 by an impact of deployment of the airbag device 2, the hook portion 32b is hooked at a peripheral edge portion of the insertion hole 12. Thereby, the ornamental panel 3 is prevented from dropping off the instrument panel 1.

### Ornamental Panel 4

As shown in FIGS. 1 to 3, the ornamental panel 4 is mounted in a lower portion of the ornamental panel 3 in this embodiment. The ornamental panel 4 includes a body portion 40 that is elongated in the vehicle width direction. The body portion 40 is formed by injection molding a synthetic resin. The body portion 40 may be formed of a synthetic resin similar to the one used for the body portion 30 of the ornamental panel 3.

### First Fixer F1

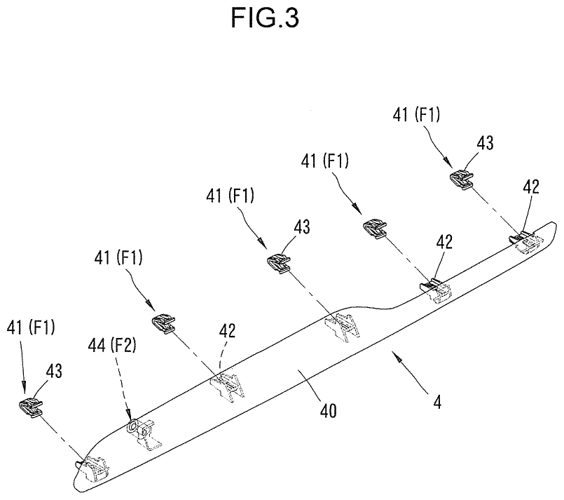

The first fixer F1 for fixing the ornamental panel 4 to the ornamental panel 3 includes a catch hole 33 shown in FIG. 1 and a catch claw 41 shown in FIG. 3. The catch hole 33 is formed in a lower portion of the body portion 30 of the ornamental panel 3. The catch claw 41 is disposed on a reverse side of the body portion 40 of the ornamental panel 4. In this embodiment, five (plurality of) catch holes 33 are disposed spacedly arranged in the vehicle width direction and five catch claws 41 respectively corresponding to the five catch holes 33 are disposed in the reverse side of the body portion 40 spacedly arranged in the vehicle width direction.

As shown in FIG. 3, the catch claw 41 of the ornamental panel 4 includes a mounting plate portion 42 and a clip 43. The mounting plate portion 42 is integrally formed with the body portion 40 and is protruded toward the ornamental panel 3. The clip 43 is disposed in a distal end portion of the mounting plate portion 42. The clip 43 is made of a synthetic resin or a metal and is elastic. The catch claw 41 may have the mounting plate portion 42 and the clip 43 integrally formed therewith. The clips 43 of the catch claws 41 are respectively caught in the catch holes 33 (FIG. 1) of the ornamental panel 3. Thereby, the ornamental panel 4 is securely mounted on the ornamental panel 3.

### Second Fixer F2

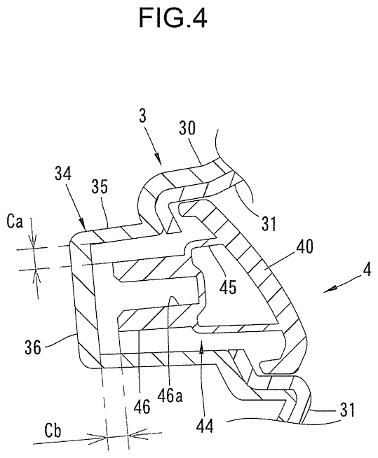

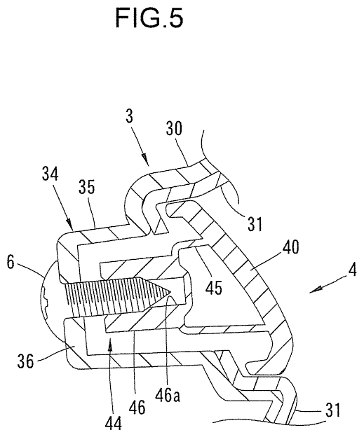

The second fixer F2 is provided to complement a fixation strength between the ornamental panel 3 and the ornamental panel 4 by the first fixer F1. The second fixer F2 is preliminarily prepared for a case where the fixation strength by the first fixer F1 is not sufficient. The second fixer F2 may include a boss portion 44 shown in FIGS. 2 and 3, a receiving recess 34 shown in FIGS. 2 and 4 and a tapping screw 6 shown in FIG. 5. The boss portion 44 is provided in a reverse face of the body portion 40 of the ornamental panel 4. The receiving recess 34 is provided in the ornamental panel 3.

As shown in FIG. 3, the boss portion 44 is disposed between a first catch claw 41 and a second catch claw 41 of the body portion 40 of the ornamental panel 4 from a left in the vehicle width direction in this embodiment. As shown in FIG. 4, the boss portion 44 is formed integrally with the body portion 40 of the ornamental panel 4 in a reverse face of the body portion 40. The boss portion 44 is protruded toward the ornamental panel 3. The boss portion 44 includes a base portion 45 on a basal end side and a boss body portion 46 on a distal end side. The base portion 45 is hollow and is grater than the boss body portion 46 in a vertical direction. The boss body portion 46 has a bottomed circular cylindrical configuration and has a circular tapping hole 46a formed inside thereof.

As shown in FIG. 2, the receiving recess 34 of the ornamental panel 3 is integrally formed with the body portion 30 of the ornamental panel 3 in the lower portion of the body portion 30. The receiving recess 34 is recessed in a direction in which the boss portion 44 is protruded. As shown in FIG. 4, the receiving recess 34 includes a side wall portion 35 and a bottom wall portion 36. The receiving recess 34 has dimensions that allow the boss body portion 46 to be received therein. A clearance Ca is provided between the boss body portion 46 and the side wall portion 35. A clearance Cb is provided between a distal end of the boss body portion 46 and the bottom wall portion 36.

As shown in FIG. 5, in the second fixer F2, the tapping screw 6 can be screwed into the bottom wall portion 36 and the tapping hole 46a from a reverse side of the ornamental panel 3 as necessary. Thereby, the ornamental panel 4 can be fixed to the ornamental panel 3.

When the fixation by the second fixer F2 is not adopted, the boss body portion 46 and the receiving recess 34 are not contacted with each other because of the clearances Ca and Cb shown in FIG. 4. Thanks to this arrangement, generation of abnormal noises while the vehicle is moving can be prevented.

### Determination of Use or Non-Use of Second Fixer F2

Regarding the mounting structure of the ornamental panel 4 to the ornamental panel 3 mentioned above, a test is conducted in a prototype stage before production simulating the impact of the deployment of the airbag device 2. If in the test, the fixation of the ornamental panel 4 to the ornamental panel 3 by the first fixer F1 is found to provide a sufficient fixation strength, the prototype may be put into production without being further fixed by the second fixer F2.

If in the test mentioned above, the fixation strength of the ornamental panel 4 to the ornamental panel 3 by the first fixer F1 is found insufficient, the ornamental panels 3, 4 will be further fixed by the second fixer F2 as mentioned above in products to be put into the market.

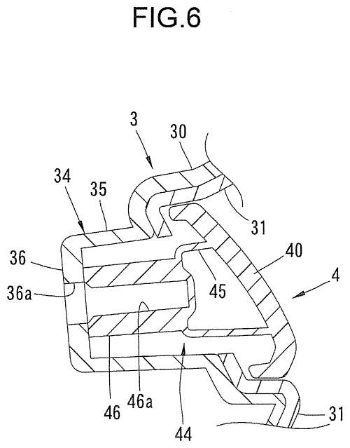

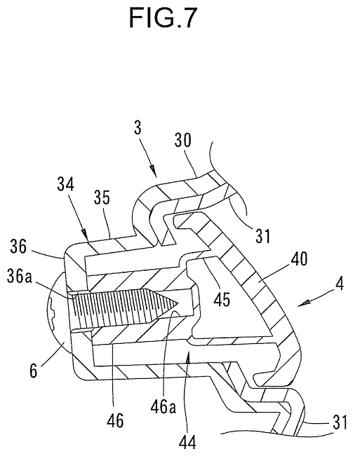

In the fixation by the second fixer F2, it is preferable for screwing the tapping screw 6 as shown in FIG. 7 that the distal end of the boss body portion 46 is abutted against the bottom wall portion 36 and an under hole 36a opposed to the tapping hole 46a of the boss body portion 46 is formed in the bottom wall portion 36 as shown in FIG. 6. To realize this preferred condition, specifications of the ornamental panels 3, 4 may be changed to make a protrusion length of the boss body portion 46 longer and to have the under hole 36a formed in the bottom wall portion 36 before being put into production.

### Injection Mold 7 for the Ornamental Panel 3

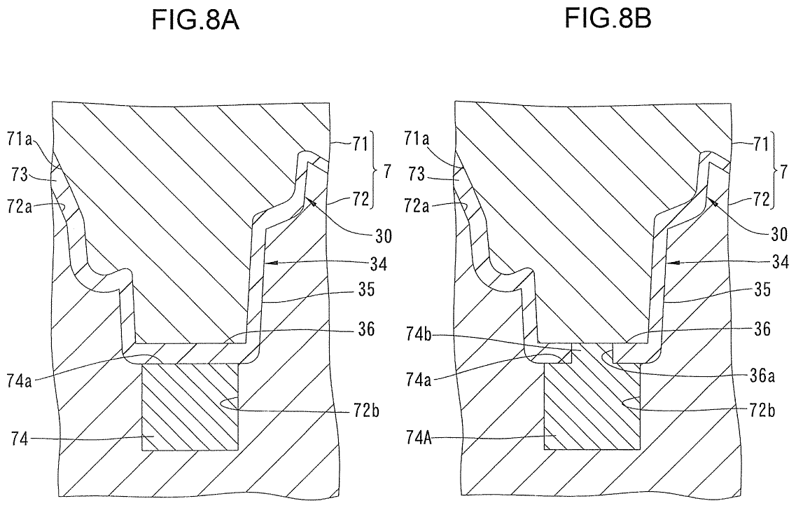

The ornamental panel 3 having the features mentioned above can be molded with an injection mold 7 shown in FIG. 8A. The injection mold 7 includes a fixed mold 71 and a movable mold 72. A molding space 73 is provided between a molding surface 71a of the fixed mold 71 and a molding surface 72a of the movable mold 72 to form the body portion 30 and the receiving recess 34 of the ornamental panel 3.

An insert receiving portion 72b open to the molding surface 72a is formed in the movable mold 72. An insert 74 is exchangeably received in the insert receiving portion 72b. The bottom wall portion 36 of the receiving recess 34 is formed by an upper end surface 74a of the insert 74 and the molding surface 71a of the fixed mold 71 opposed to the upper end surface 74a.

In a case where the second fixer F2 is used for fixing the ornamental panel 4 to the ornamental panel 3 and the under hole 36a is formed in the bottom wall portion 36 as shown in FIG. 6 to facilitate screwing of the tapping screw 6, an insert 74A shown in FIG. 8B is used in place of the insert 74 in the injection mold 7. The insert 74A includes a circular cylindrical convex portion 74b (protruded portion) on the upper end surface 74a. The convex portion 74b is disposed in the molding space 73, and thereby the under hole 36a is formed in the bottom wall portion 36.

In the injection mold 7 having the features mentioned above, specification changes of the ornamental panel 3 to form the under hole 36a in the bottom wall portion 36 can be coped with by exchanging the inserts. Therefore, it requires little time to finish the mold so as to form the ornamental panel 3 according to the design with the specification changes. Thus, time required for final finishing can be reduced.

### Injection Mold 8 for the Ornamental Panel 4

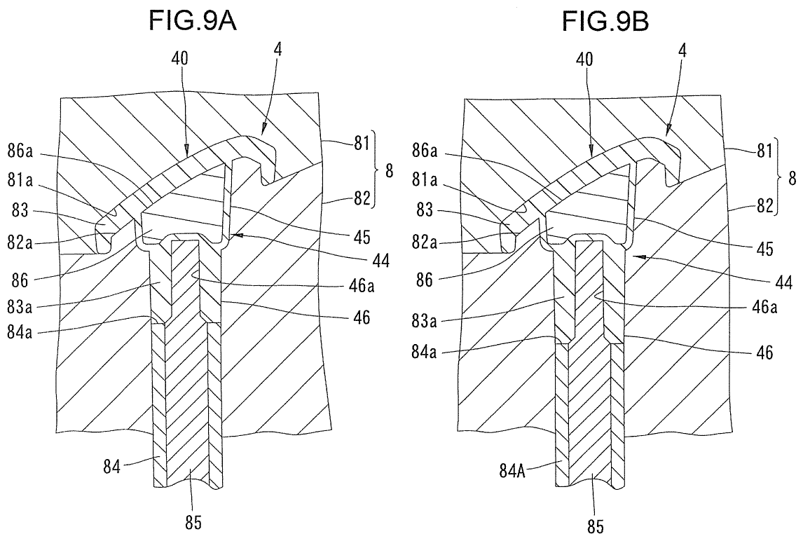

The ornamental panel 4 having the features mentioned above can be molded with an injection mold 8 shown in FIG. 9A. The injection mold 8 includes a fixed mold 81 and a movable mold 82. A molding space 83 is provided between a molding surface 81a of the fixed mold 81 and a molding surface 82a of the movable mold 82 to form the body portion 40 and the boss portion 44 of the ornamental panel 4.

A boss portion forming cavity 83a open to the molding surface 82a is formed in the movable mold 82. A sleeve pin 84 is slidably inserted in the boss portion forming cavity 83a. A center pin 85 is slidably fitted in an inner periphery of the sleeve pin 84. The center pin 85 is protruded further in the boss portion forming cavity 83a than an upper end surface 84a of the sleeve pin 84. A slidable piece 86 is disposed above the center pin 85.

In the injection mold 8 having the features mentioned above, the body portion 40 of the ornamental panel 4 is formed between the molding surface 81a of the fixed mold 81 and the molding surface 82a of the movable mold 82 and between the molding surface 81a and an upper end surface 86a of the slidable piece 86. The base portion 45 integrally formed with the body portion 40 is formed by the slidable piece 86 and the boss portion forming cavity 83a. The boss body portion 46 integrally formed with the base portion 45 is formed by the upper end surface 84a of the sleeve pin 84 and the boss portion forming cavity 83a. The tapping hole 46a is formed in the boss body portion 46 by the center pin 85 protruded further than the sleeve pin 84.

After molding the ornamental panel 4 with the injection mold 8, the movable mold 82 is moved with respect to the fixed mold 81 and the slidable piece 86 is slid in a direction orthogonal to the plane of FIG. 9A. Then, the sleeve pin 84 is pushed up toward the fixed mold 81. Thereby, the boss portion 44 is pulled out of the boss portion forming cavity 83a, and the ornamental panel 4 is removed from the mold.

In a case where the second fixer F2 is used for fixing the ornamental panel 4 to the ornamental panel 3 and a protrusion length of the boss body portion 46 is increased to be long enough for the distal end of the boss body portion 46 to be abutted against the bottom wall portion 36 as shown in FIG. 6 to facilitate screwing of the tapping screw 6, a sleeve pin 84A shown in FIG. 9B is used in place of the sleeve pin 84 in the injection mold 8. The sleeve pin 84A is shorter than the sleeve pin 84. An upper end surface 84a of the sleeve pin 84A is disposed at a deeper location than the upper end surface 84a of the sleeve pin 84 with respect to the molding surface 82a in the boss portion forming cavity 83a. In this arrangement, the boss body portion 46 having a long protrusion length is molded.

In the injection mold 8 having the features mentioned above, specification changes of the ornamental panel 4 to make the protrusion length of the boss body portion 46 longer can be coped with by exchanging the sleeve pins. Therefore, it requires little time to finish the mold so as to form the ornamental panel 4 according to the design with the specification changes. Thus, time required for final finishing can be reduced.

### Effects of the Embodiment Given Above

According to the embodiment mentioned above, the structures constituting the second fixer F2 are preliminarily provided in the ornamental panels 3, 4. If the fixation strength between the ornamental panel 3 and the ornamental panel 4 by the first fixer F1 is not sufficient, the fixation strength can be enhanced by the second fixer F2 including the screwing of the tapping screw 6.

Thanks to the clearances Ca, Cb provided between the boss body portion 46 of the ornamental panel 4 and the receiving recess 34 of the ornamental panel 3 constituting the second fixer F2, generation of abnormal noises while the vehicle is moving can be prevented when the fixation strength by the first fixer F1 is sufficient and the second fixer F2 is not used for fixation.

When the second fixer F2 is used for fixation, the specifications of the ornamental panels 3, 4 can be easily changed to improve workability of the screwing of the tapping screw 6. The specifications may be changed such that the boss body portion 46 of the ornamental panel 4 is abutted against the bottom wall portion 36 of the ornamental panel 3 and the under hole 36a is formed in the bottom wall portion 36. Such specification changes can be made easily by exchanging the insert 74 of the injection mold 7 for the ornamental panel 3 with the insert 74A and exchanging the sleeve pin 84 of the injection mold 8 for the ornamental panel 4 with the sleeve pin 84A. Further, these arrangements bring about reduction of time required for final finishing of the injection mold 7 and the injection mold 8.

### MODIFICATION EXAMPLES

The present disclosure is not limited to the embodiment mentioned above and various modifications may be made without departing from the scope of the disclosure.

In the embodiment mentioned above, the present disclosure is applied to the structure for mounting the ornamental panel 4 on the ornamental panel 3 (interior material). Alternatively, the present disclosure may be applied to a structure for mounting an ornamental panel on an instrument panel or to other structures for mounting an ornament panel on other interior materials.

The first fixer F1 for fixing the ornamental panel 4 to the ornamental panel 3 is not limited to the catching of the catch claw 41 by the catch hole 33. The first fixer F1 may be other fixing means including sticking using a double-faced adhesive tape, adhesion using an adhesive, welding, and the like.

The second fixer may be provided in a plurality of locations.

The present disclosure may be applied to a structure for mounting an ornamental panel on a vehicle interior material.

According to the present invention, a structure for mounting an ornamental panel on a vehicle interior material can be provided, in which when a fixation strength by a first fixer is not sufficient, the fixation strength can be enhanced by a second fixer.

Although an example embodiment and modification examples of the disclosure are described hereinabove, the foregoing embodiment and modification examples are mere examples and are not intended to limit the scope of the disclosure. It should be also appreciated that various omissions, replacements, and modifications may be made in the foregoing embodiment and modification examples described herein, without departing from the scope of the disclosure. The disclosure is intended to include such modifications and alterations in so far as they fall within the scope of the appended claims or the equivalents thereof.

1. A structure for mounting an ornamental panel on a vehicle interior material having an airbag device disposed in a reverse face side of the vehicle interior material, wherein:
the interior material and the ornamental panel comprise an injection molded resin;
the ornamental panel is fixed to the interior material by a first fixer;
the ornamental panel can be fixed to the interior material by a second fixer;
the second fixer comprises a boss portion and a receiving recess;
the boss portion having a tapping hole is protrudedly disposed on a reverse side of the ornamental panel;
the receiving recess recessed in a protrusion direction of the boss portion is formed in the interior material;
the receiving recess receives the boss portion;
the receiving recess comprises a bottom wall portion opposed to a distal end of the boss portion; and
a protrusion length of the boss portion is determined such that a clearance is formed between the bottom wall portion and the distal end of the boss portion.

2. The structure for mounting the ornamental panel on the vehicle interior material according to claim 1, wherein the second fixer comprises a tapping screw, and wherein the tapping screw is screwed into the tapping hole of the boss portion from a reverse side of the bottom wall portion.

3. A structure for mounting an ornamental panel on a vehicle interior material having an airbag device disposed in a reverse face side of the vehicle interior material, wherein:
the interior material and the ornamental panel comprise an injection molded resin;
the ornamental panel is fixed to the interior material by a first fixer;
the ornamental panel is further fixed to the interior material by a second fixer that adds to a fixation strength by the first fixer;
the second fixer comprises a tapping screw, a boss portion and a receiving recess;
the boss portion having a tapping hole is protrudedly disposed on a reverse side of the ornamental panel;
the receiving recess recessed in a protrusion direction of the boss portion is formed in the interior material;
the receiving recess receives the boss portion;
the receiving recess comprises a bottom wall portion opposed to a distal end of the boss portion;
an under hole opposed to the tapping hole of the boss portion is formed in the bottom wall portion;
a height of the boss portion is determined such that the bottom portion and the distal end of the boss portion are abutted against each other; and
the tapping screw is screwed into the tapping hole of the boss portion from a reverse side of the bottom wall portion through the under hole.
